(19) United States
(12) Patent Application Publication
(10) Pub. No.: US 2003/0023739 A1
(43) Pub. Date: Jan. 30, 2003

(54) System and method for multi-tier multi-casting over the Internet

(76) Inventor: Lan Ngoc Vu, Austin, TX (US)

Correspondence Address: Jeffrey Van Myers, P.O. Box 130, Driftwood, TX, 78619, US

(21) Appl. No.: 09/917,412

(22) Filed: Jul. 28, 2001

(51) Int. Cl. G06F 15/16

(52) U.S. Cl. 709/230; 709/203

(57) ABSTRACT

System and method adapted to multi-cast over the Internet using multiple tiers of servers. Preferably, the content server transmits content to servers in the next lower tier, which may include one or more client servers, using multi-cast, but may use uni-cast. Preferably, each server in all intermediate tiers transmits content to the servers in the next lower tier, which may include one or more client servers, using multi-cast, but may use uni-cast. Each client server transmits to its clients using multi-cast. The quality of a live cast received by each client server may be improved using the more efficient UDP/IP for downloading the bulk of the content and compensating for the occasional lost segments of data using the more reliable TCP/IP.

### CROSS-REFERENCE TO RELATED APPLICATIONS

The present invention is related to the following co-pending applications for patents:

“System and Method for Facilitating Business-to-Business Business”, U.S. application Ser. No. 09/597,359, filed Jun. 19, 2000 and assigned to the assignee hereof (“First Application”);

“System and Method for Dynamic Local Caching of Web Content”, U.S. application Ser. No. 09/699,093, filed Oct. 28, 2000 and assigned to the assignee hereof (“Second Application”); and

“System and Method for Secure Communication Over the Internet”, having Attorney Docket No. JWO004-00, filed concurrently herewith and assigned to the assignee hereof (“Third Application”).

### BACKGROUND OF THE INVENTION

1. Technical Field

Our invention relates generally to a method and apparatus for multi-casting over a public communication network.

2. Background Art

In general, in the descriptions that follow, we will italicize the first occurrence of each special term of art which should be familiar to those skilled in the art of network communication systems. In addition, when we first introduce a term that we believe to be new or that we will use in a context that we believe to be new, we will bold the term and provide the definition that we intend to apply to that term. In addition, throughout this description, we may use the terms assert and negate when referring to the rendering of a signal, signal flag, status bit, or similar apparatus into its logically true or logically false state, respectively.

While the number of single entity intra-nets continually increases, most multi-site entities utilize public networks for inter-site transactions. Since the Internet is the best known of the public networks, we will tend to refer to it hereafter (or to its alter ego, the World Wide Web (“WWW”)or just Web) for purposes of example. However, numerous Internet service providers or ISPs have set up their privately-owned networks so as to be semi-autonomous from the remainder of the Internet, thereby allowing their subscribers to exploit the many advantages inherent in such intra-ISP communication facilities. For our purposes, therefore, we intend the term “public network” to include any network to which a member of the public, in our case any business entity, can obtain access by payment of a periodic service fee. Thus, we distinguish such intra-ISP-networks from truly private networks that are owned and operated by single organizations, such as large corporations, and to which access is limited to only members (e.g., employees) of that organization (these we will refer to as “iNets”). For purposes of this application, we shall refer hereinafter to an employee connected to an iNet as if she were a client of the business systems that have been fully and completely disclosed in the First and Second Applications.

An increasingly popular use of iNets is in live broadcasting of events of entity-wide interest, such as all-employee communications meetings. In general, uni-casting has been used to deliver, point-to-point, a selected content to a single client. In contrast, multi-casting has been used to simultaneously deliver, point-to-multi-point, the same content to multiple clients. One significant advantage of multi-casting over uni-casting is the reduced bandwidth demands placed upon the content server. However, delivery of multi-cast content via the Internet is not without risk since many intermediate routers in the Internet route from the content server to the client are configured by their owners to block multi-cast transactions.

Assume for a moment that a business desires to conduct a multi-cast session to deliver content originating at a central site (e.g., corporate headquarters) to several clients (e.g., the “troops”) located at a remote site. Assume also that all of the clients are connected to a common, site-specific iNet that incorporates a single client server connected via the Internet to the content server located at the central site. Using current technology, each of the clients will demand from the client server the full bandwidth required to receive the multi-cast content. It can be seen, therefore, that conventional multi-casting can also rapidly exhaust the available bandwidth of the client server, not only degrading the quality of the multi-cast itself, but also negatively impacting the ability of the client server to fulfill all other Internet communication requirements. What is needed, we submit, is a multi-casting system and method for conserving the bandwidth not only of the content server but also of the local client server.

Transmission Control Protocol (“TCP”) is a method used along with the Internet Protocol (“IP”) to send data in the form of message units, called packets, between computers over the Internet. TCP is known as a connection-oriented protocol, which means that a connection is established and maintained until such time as the message or messages to be exchanged by the application programs at each end have been exchanged. While IP handles the actual delivery of the data, TCP keeps track of the individual packets into which a message is divided for efficient routing through the Internet. TCP is responsible both for ensuring that a message is divided into the packets that IP manages, and for reassembling the packets back into the complete message at the other end. For example, when a live cast is transmitted from a content server, the TCP program layer in that server divides the continuous audio/video stream into a series of packets, sequentially numbers those packets, and then forwards them individually to the IP program layer. Although each packet has the same destination IP address, it may get routed differently through the Internet. At the receiving computer, TCP reassembles the individual packets and waits until all have arrived to forward them to the application program as a single, contiguous file.

The objective of TCP is to provide a reliable, connection-oriented delivery service. TCP views data as a stream of bytes, not frames. The unit of transfer is referred to as a segment. To provide the connection-oriented service, TCP takes care to ensure reliability, flow control, and connection maintenance. TCP is able to recover from data that is damaged, lost, duplicated, or delivered out of sequence. In order to do this, the content server's TCP assigns a sequence number to each byte to be transmitted. For each byte received, the client server's TCP must return an Acknowledge (“ACK”) within a specified period. If this is not done, the content server will retransmit the data. Damaged data is handled by adding a checksum to each segment. If a segment is detected as damaged by the client server's TCP, it will discard the segment and return no ACK. Receiving no ACK, the content server will automatically resend the segment.

User Datagram Protocol (“UDP”) is a communications method that offers a limited amount of service when messages are exchanged between computers in a network that uses IP. Like TCP, UDP uses IP to actually get a data unit (called a datagram) from a content server to a client server. Unlike TCP, however, UDP does not provide the service of dividing a message into packets and reassembling it at the other end. Specifically, UDP doesn't provide sequencing of the data packets. This means that an application program that uses UDP must be able to make sure that the entire message has arrived and is in the correct order. UDP provides two services not provided by the IP layer: port number to help distinguish different user requests, and, optionally, a checksum capability to verify that the data arrived intact.

Conventional live casts typically utilize UDP rather than TCP, primarily because of its more efficient use of available bandwidth. Given the generally unreliable nature of the Internet (in terms of being able to deliver to a given client server all packets sent by a content server) and the fact that UDP is not designed to guarantee delivery of all content, it can be anticipated that the client server will experience occasional losses of bits and pieces of the live cast content stream. Fortunately, the human sensory system is quite capable of unconsciously interpolating across small gaps in the reproduced audio and video streams. However, as these gaps get larger or more frequent, due to particularly poor Internet routing, the viewer will become conscious of the gaps, perceiving the image as jerky or disjointed. Unfortunately, UDP possesses no ability to detect, much less remedy, this situation. What is needed, we submit, is a multi-protocol system and method for selectively compensating for this weakness of UDP using the strength of TCP but which does not incur the full overhead costs of TCP.

### BRIEF SUMMARY OF THE INVENTION

In accordance with a preferred embodiment of our invention, we provide a system and method for multi-casting using multiple tiers of intermediate client servers. According to this aspect of our invention, the content server multi-casts in a conventional way to a first tier of clients, each of which may be either a true client or a client server that further multi-casts to a next lower tier of clients. In turn, each first-tier client server multi-casts the content to a next lower tier of clients, each of which, again according to our invention, may be either a true client or a client server that further multi-casts to a next lower tier of clients.

In accordance with another embodiment of our invention, we provide a system and method for selectively compensating for the unreliable nature of UDP using the reliability feature of TCP. According to this aspect of our invention, the content server transmits a sequentially numbered series of datagrams using UDP. Upon receipt, a client server verifies each datagram's assigned sequence number and locally stores each datagram in the correct sequential order. If an out-of-order datagram is received, the client server assumes that all datagrams between the last sequentially numbered datagram and the most recently received datagram have been lost. Using TCP, the client server requests the content server to resend each lost datagram and, upon receipt, merges each into the stored stream according to sequence number. Preferably, the client server buffers the incoming stream with respect to the presentation to the client so as to allow sufficient time to repair a reasonable number of datagram losses. This buffer period can be dynamically varied to accommodate greater or lesser rates of loss.

### BRIEF DESCRIPTION OF THE SEVERAL VIEWS OF THE DRAWINGS

Our invention may be more fully understood by a description of certain preferred embodiments in conjunction with the attached drawings in which:

FIG. 1 illustrates in block diagram form a business system adapted, in part, to multi-cast in accordance with the prior art, and, in part, to provide multi-tier multi-casting according to the preferred embodiment of our invention;

FIG. 2 illustrates in block diagram form a business system as in FIG. 1 which implements multi-protocol, live-casting according to the preferred embodiment of our invention;

FIG. 3 illustrates in flow diagram form the method of operation of the system of FIG. 2;

FIG. 4 illustrates in flow diagram form the compensation process of the system of FIG. 2; and

FIG. 5 illustrates in flow diagram form the stream playback process of the system of FIG. 2.

### DETAILED DESCRIPTION OF THE INVENTION

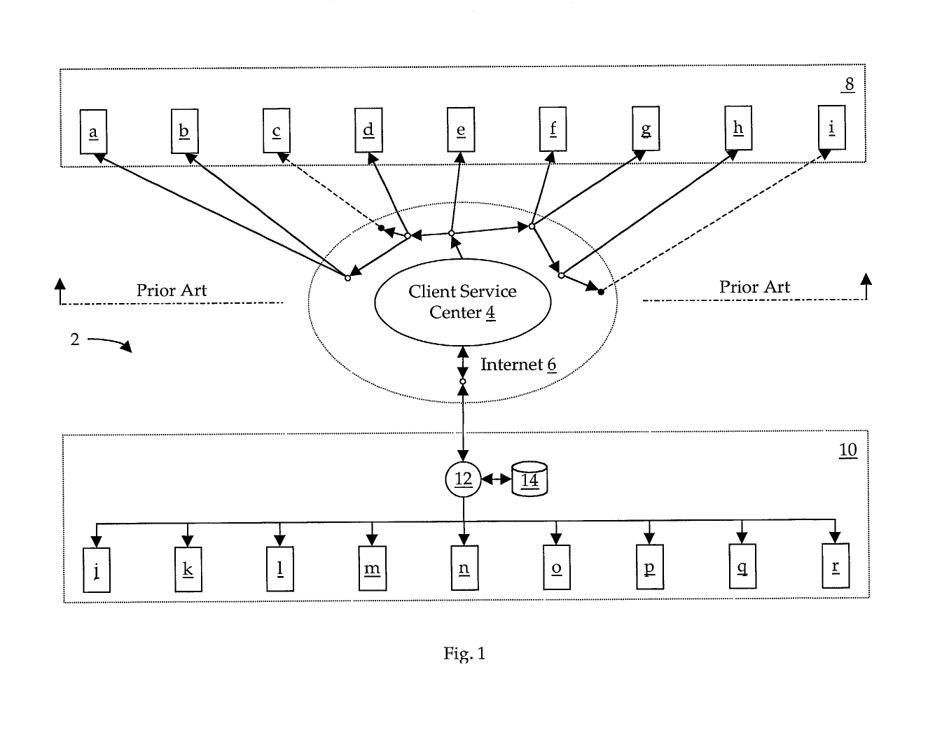

Shown in FIG. 1 is a business system 2 having a client service center 4 that can be accessed electronically via the Internet 6 by a plurality of businesses, including for example a first business site 8 and a second business site 10. Each member business may subscribe for any of the several services available from our client service center 4. A number of such services are described in the First and Second Applications. One new service, described hereinafter, is the multi-casting of live content. In general, each business may select either conventional multi-casting or our new multi-tier multi-casting.

As shown in FIG. 1, within business site 8, each of the clients, from client_a through client_i must establish a separate point-to-point connection with the client service center 4. In general, the path through the Internet between the client service center 4 and each of our clients in business site 8 will depend upon numerous factors, including physical location, local ISP access service and dynamic loading factors. In the illustrated connection scheme, both client_c and client_i are prohibited from receiving the multi-cast content because at least one of the routers in the connection path are configured to block multi-cast transactions (for convenience of reference, these routers are shown as darkened “dots” within Internet 6 and the downstream paths in their shadow are represented in dashed lines). In such prior art systems, the content server, in this case our client service center 4, will be unaware of such service blockages. The only alternative available to client_c and client_i is to request a uni-cast connection. For each such request granted, the bandwidth load on the content server is increased accordingly.

In accordance with our invention, within business site 10, it is our client server 12 that establishes the connection with the client service center 4, usually in response to the first request that it receives from any of its clients, say client_k. Initially, client server 12 will register itself with the client service center 4 as a participant in the multi-cast UDP session. Then, when the client service center 4 is actually ready to initiate the multi-cast session, the client service center 4 will multi-cast to all registered participants, including client server 12, an initial datagram of information regarding the multi-cast session. In response to receiving this datagram, the client server 12 will send back to the client service center 4 an ACK. Preferably, our client service center 4 will maintain a register of all participants and their acknowledgements, and, if a participant, say client server 12, fails to timely acknowledge, it can be assumed that the connection path is either blocked to multi-cast transactions or otherwise unacceptable. The client service center 4 can then cooperate with the client server 12 to establish a uni-cast TCP connection.

Alternatively, if desired, all participants, including the client server 12, can be configured to simply wait a predetermined time period after the scheduled time for the start of the multi-cast session and, if no content has been received, to contact the client service center 4 and establish a suitable uni-cast TCP connection. This self-reliant procedure, since it is controlled entirely by our client server 12, is suitable for use with content servers that are not as sophisticated as our client service center 4.

Upon establishing a suitable connection path with our client service center 4, the client server 12 then establishes a second tier, multi-cast session within business site 10. Thereafter, if another client, say client_n, requests to participate in the multi-cast session, our client server 12 will establish the necessary local connections and allow both client_k and client_n to simultaneously view the multi-cast content.

As explained in the First and Second Applications, our client server 12 can automatically perform dynamic local data caching of content received via the Internet 6 on a local storage media, such as disk 14. In accordance with our present invention, our client server 12 is now able to dynamically cache the various components of the multi-cast itself, including both audio and video. Using this capability, it is possible for a client, say client_p, to join the multi-cast late and still view the entire multi-cast content, albeit delayed by the lapse in time between the actual start of the multi-cast and the time of viewing. In point of fact, if the space allocated on the disk 14 to cache the multi-cast content is sufficient, the entire content can be saved for off-line viewing whenever convenient. If desired, any client, say client_m, can save the cached content on a local storage device (not shown).

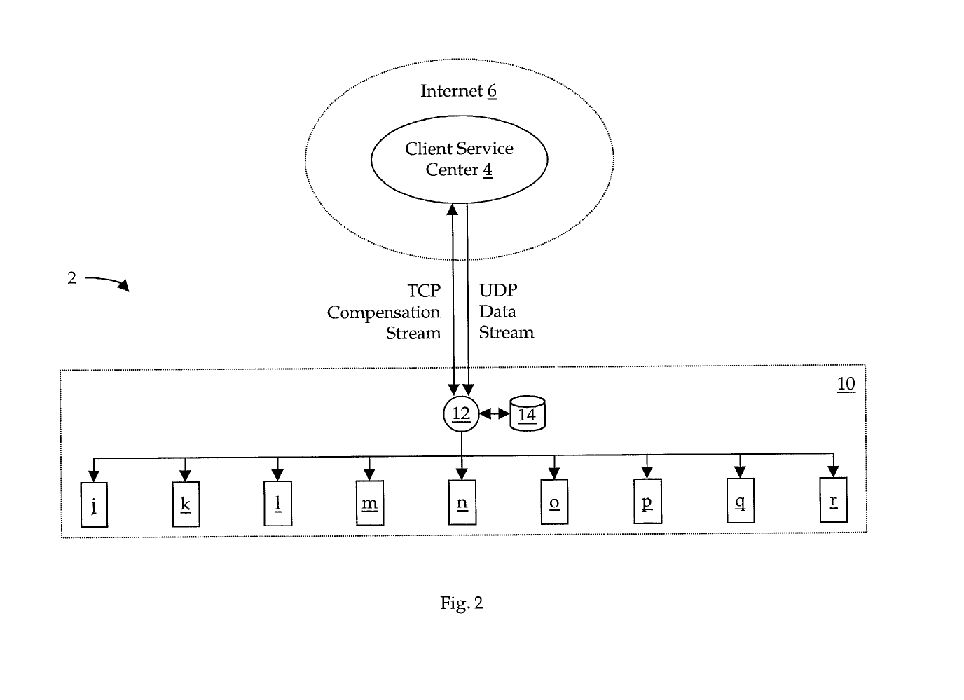

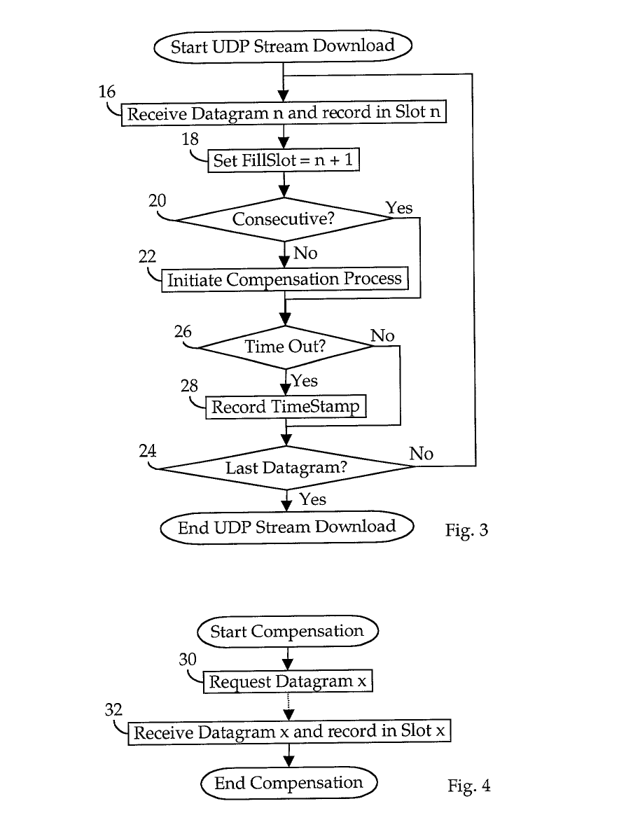

Shown in FIG. 2 is an embodiment of our invention that is particularly well suited for live casting. In the method of operation shown in FIG. 3, our client server 12, after initiating a UDP steam download, will receive each datagram, and then record that datagram in a corresponding one of a set of slots on the disk 14 where space has been allocated to store the datagrams (step 16). For buffer management reasons, to be described below, the client server 12 will then set in a variable (we call it FillSlot) to the sequence number of the datagram (step 18). The client server 12 will then ascertain from the associated datagram number if the datagram is, in fact, the next sequential datagram (step 20). If the datagram is determined to be not in sequence, the client server 12 will initiate a compensation process (described below) (step 22). In any event, if additional datagrams are expected (step 24), the client server 12 is now free to perform other operations while awaiting the arrival of the next datagram.

In accordance with the preferred embodiment of our invention, our client server 12 will keep track of time (step 26), and, at periodic intervals (say, every 60 seconds or so), record, in association with the then-current datagram, a time stamp indicative of the time period that has elapsed since the start of the live cast (step 28). In general, such time stamps enable our client server 12 to allow a client to begin viewing of a recorded live cast at any of the stamped points in time.

In general, the compensation process shown in FIG. 4 will be performed whenever the client server 12 determines that one or more of the datagrams are missing. In each such event, the client server 12 will send a TCP request to our client service center 4 to provide the missing datagram (step 30). Upon receipt (again using TCP), the missing datagram is recorded in the corresponding slot (step 32). By using TCP, we are guaranteed to receive the requested missing datagram. Assuming that most of the datagrams comprising the complete live cast stream, the loading on both the client service center 4 and the client server 12 for performing compensation should be acceptable. If desired, either server may limit the use of compensation if overall system load exceeds acceptable limits.

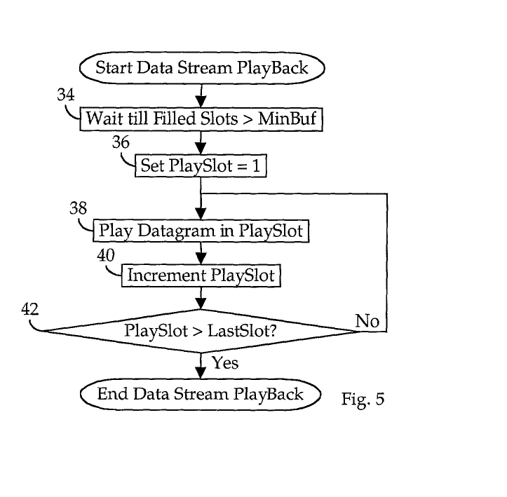

In accordance with the playback process shown in FIG. 5, the client server 12 waits until the number of filled slots exceeds the value of a variable (we call it MinBuf) (step 34). In general, we set MinBuf so as to allow sufficient time to repair a reasonable number of datagram losses. This buffer period can be dynamically varied to accommodate greater or lesser rates of loss. Our studies indicate that a buffer sized to accommodate around 40 seconds or so of the live cast stream is sufficient for quality purposes while still preserving the impression of real time presentation to our client(s).

Once the buffer is sufficiently full, the client server 12 sets a variable (we call it PlaySlot) to indicate that playback is to begin with the datagram stored in slot 1 (step 36). Once each datagram is played (step 38), the client server 12 increments PlaySlot (step 40) and then loops back so long as there are additional stored datagrams (step 42).

Thus it is apparent that we have provided a method and system for multi-tier multi-casting over the Internet. Those skilled in the art will recognize that modifications and variations can be made without departing from the spirit of our invention. Therefore, we intend that our invention encompass all such variations and modifications as fall within the scope of the appended claims.

What we claim is:

1. A system for multi-tier multi-casting via a public communication network, comprising:
a content server adapted to multi-cast predetermined content via the public communication network, wherein the content server comprises a first tier;
a first client server adapted to receive the content multi-cast by the content server via the public communication network, and to multi-cast the received content via a first private communication network, wherein the first client server comprises a second tier; and
a first client adapted to receive the content multi-cast by the first client server via the first private communication network.

2. The system of claim 1 further comprising:
a second client server adapted to receive the content multi-cast by the content server via the public communication network, and to multi-cast the received content via a second private communication network, wherein the first and second client servers comprise said second tier; and
a second client adapted to receive the content multi-cast by the second client server via the second private communication network.

3. The system of claim 2 further comprising:
a third client adapted to receive the content multi-cast by the second client server via the second private communication network.

4. The system of claim 1 further comprising:
a third client adapted to receive the content multi-cast by the first client server via the first private communication network.

5. A method for multi-tier multi-casting via a public communication network, the method comprising the steps of:
multi-casting predetermined content via the public communication network;
receiving the content multi-cast via the public communication network, and multi-casting the received content via a first private communication network; and
receiving the content multi-cast via the first private communication network.

6. The method of claim 5 further comprising:
receiving the content multi-cast via the public communication network, and multi-casting the received content via a second private communication network; and
receiving the content multi-cast via the second private communication network.

7. A method for reliably communicating content via a public communication network, the method comprising the steps of:
receiving content for communication via the public communication network;
dividing the received content into a plurality of datagrams, each datagram comprising a respective portion of the content and a sequentially assigned sequence number indicative of the relationship of said content portion to said content;
transmitting each datagram via the public communication network using User Datagram Protocol (UDP);
receiving a datagram transmitted via the public communication network using UDP;
storing the content portion of the received datagram in a location corresponding to the sequence number thereof;
if the content portion of the received datagram is the not next sequential portion of the content:
transmitting, via the public communication network, a request to transmit at least said next sequential content portion via the public communication network;
receiving said request and, in response thereto, transmitting said requested at least next sequential content portion via the public communication network using Transmission Control Protocol (TCP);
receiving said requested at least next sequential content portion transmitted via the public communication network using TCP; and
storing the received at least next sequential content portion in a location corresponding to the sequence thereof; and
presenting the stored content portions in accordance with the sequence numbers thereof.

8. A system for reliably communicating content via a public communication network, the system comprising:
a content server adapted to:
receive content for communication via the public communication network;
divide the received content into a plurality of datagrams, each datagram comprising a respective portion of the content and a sequentially assigned sequence number indicative of the relationship of said content portion to said content;
transmit each datagram via the public communication network using User Datagram Protocol (UDP); and
receive, via the public communication network, a request to transmit at least said next sequential content portion via the public communication network, and, in response thereto, transmit said requested at least next sequential content portion via the public communication network using Transmission Control Protocol (TCP);
a client server adapted to:
receive a datagram transmitted via the public communication network using UDP;
store the content portion of the received datagram in a location corresponding to the sequence number thereof;
if the content portion of the received datagram is the not next sequential portion of the content:
transmit, via the public communication network, said request to transmit at least said next sequential content portion via the public communication network;
receive said requested at least next sequential content portion transmitted via the public communication network using TCP; and
store the received at least next sequential content portion in a location corresponding to the sequence thereof; and
present the stored content portions in accordance with the sequence numbers thereof.
